(19) United States
(12) Patent Application Publication
(10) Pub. No.: US 2013/0161864 A1
(43) Pub. Date: Jun. 27, 2013

(54) SUBSTRATE STRUCTURE AND METHOD FOR MAKING THE SAME

(71) Applicant: Chi Mei Corporation, Tainan City (TW)

(72) Inventors: Yu-Hao LIANG, Kaohsiung City (TW); Jen-Hao Hsueh, Tainan City (TW); Huai-Pin Hsueh, Tainan City (TW)

(73) Assignee: CHI MEI CORPORATION, Tainan City (TW)

(21) Appl. No.: 13/726,824

(22) Filed: Dec. 26, 2012

(30) Foreign Application Priority Data
Dec. 26, 2011 (TW) 100148604

(51) Int. Cl. C08L 77/06; B29C 41/22; B05D 5/00

(52) U.S. Cl. CPC C08L 77/06; B05D 5/00; B29C 41/22
USPC 264/241; 427/385.5; 427/289; 428/473.5; 428/331

(57) ABSTRACT

A substrate structure includes a support, a release layer releasably disposed on the support, and a flexible substrate disposed on the release layer. The release layer is made from a polymer composition including a polymer component obtained by subjecting a diamine component (A) and a tetracarboxylic dianhydride component (B) to a polymerization reaction.

### CROSS-REFERENCE TO RELATED APPLICATION

This application claims priority of Taiwanese Application No. 100148604, filed on Dec. 26, 2011.

### BACKGROUND OF THE INVENTION

1. Field of the Invention

This invention relates to a substrate structure, more particularly to a substrate structure having a release layer for an electronic device. The invention also relates to a method for making the substrate structure.

2. Description of the Related Art

In view of the trend toward light weight, thin profile, and cost reduction, the conventional glass substrate structure has been substituted with a flexible plastic substrate structure in the field of flat panel displays. The method for making the flexible plastic substrate structure includes the steps of forming a flexible plastic substrate on a support, forming an integrated circuit or a color layer on the flexible plastic substrate, and stripping the flexible plastic substrate from the support to obtain the flexible plastic substrate structure.

In the conventional method for making the flexible plastic substrate structure, the support is removed from the flexible plastic substrate structure by laser cutting treatment. However, the flexible plastic substrate and the integrated circuit or the color layer formed thereon are liable to swell or be impaired due to the heat produced during the laser cutting treatment. Furthermore, the equipment for performing the laser cutting treatment is expensive so that the production cost is relatively high.

U.S. Pat. No. 8,173,249 discloses a substrate structure applied in flexible electrical devices and a fabrication method thereof. The fabrication method includes the steps of providing a carrier, forming a release layer on the carrier, and forming a flexible substrate on the release layer and the carrier followed by a cutting treatment and a stripping treatment. The cutting treatment can be performed in a common manner. The stripping treatment can be performed in a common physical manner because of the specific design of the release layer. However, relatively expensive material, such as parylene or cyclic olefin copolymer, should be used because of the heat resistance requirement. Furthermore, in the preparation of a release layer, it should be formed by a relatively complicated step of vapor deposition, and the release layer thus formed cannot be subjected to a rework operation. The yield for the fabrication method is hard to be raised, and thus the fabrication method is not widely accepted in the industry.

### SUMMARY OF THE INVENTION

Therefore, an object of the present invention is to provide a substrate structure which has improved transparency and release property.

According to the first aspect of this invention, there is provided a substrate structure, which includes a support, a release layer releasably disposed on the support, and a flexible substrate disposed on the release layer. The release layer is made from a polymer composition including a polymer component obtained by subjecting a diamine component (A) and a tetracarboxylic dianhydride component (B) to a polymerization reaction.

According to the second aspect of this invention, there is provided a method for making the substrate structure, which includes the steps of forming a release layer on a support, and forming a flexible substrate on the release layer. The release layer is made from a polymer composition including a polymer component obtained by subjecting a diamine component (A) and a tetracarboxylic dianhydride component (B) to a polymerization reaction.

### BRIEF DESCRIPTION OF THE DRAWING

Other features and advantages of the present invention will become apparent in the following detailed description of the preferred embodiments with reference to the accompanying drawings, of which:

FIG. 1 is a schematic view of a first preferred embodiment of a substrate structure according to this invention;

FIG. 2 is a schematic view of a second preferred embodiment of a substrate structure according to this invention; and

FIG. 3 is a schematic view illustrating a position for performing a cutting treatment for the second preferred embodiment.

### DETAILED DESCRIPTION OF THE PREFERRED EMBODIMENTS

The substrate structure of the present invention includes a support, a release layer releasably disposed on the support, and a flexible substrate disposed on the release layer. The release layer is made from a polymer composition including a polymer component obtained by subjecting a diamine component (A) and a tetracarboxylic dianhydride component (B) to a polymerization reaction.

Preferably, the tetracarboxylic dianhydride component (B) includes at least one of an aliphatic tetracarboxylic dianhydride compound (B-1), an alicyclic tetracarboxylic dianhydride compound (B-2), and a fluorine-containing tetracarboxylic dianhydride compound (B-3). A total amount of the aliphatic tetracarboxylic dianhydride compound (B-1), the alicyclic tetracarboxylic dianhydride compound (B-2), and the fluorine-containing tetracarboxylic dianhydride compound (B-3) is at least 30 moles, preferably at least 40 moles, and more preferably at least 45 moles based on 100 moles of the tetracarboxylic dianhydride component (B).

When the total amount of the aliphatic tetracarboxylic dianhydride compound (B-1), the alicyclic tetracarboxylic dianhydride compound (B-2), and the fluorine-containing tetracarboxylic dianhydride compound (B-3) is at least 30 moles based on 100 moles of the tetracarboxylic dianhydride component (B), the release layer thus formed has superior transparency and release property.

The imidization extent of the polymer component is preferably at least 60%, more preferably at least 65%, and most preferably at least 70%. When the imidization extent of the polymer component is at least 60%, the release layer thus formed has superior release property.

The present invention also provides a display element, which includes a release layer, and a flexible substrate disposed on the release layer. The release layer is made from a polymer composition including a polymer component obtained by subjecting a diamine component (A) and a tetracarboxylic dianhydride component (B) to a polymerization reaction.

### Release Layer:

As described above, the release layer is made from a polymer composition including a polymer component obtained by subjecting a diamine component (A) and a tetracarboxylic dianhydride component (B) to a polymerization reaction.

### (A) Diamine Component:

The diamine component (A) includes: (A-1) an aliphatic diamine compound, (A-2) an alicyclic diamine compound, (A-3) an aromatic diamine compound, (A-4) a fluorine-containing diamine compound, (A-5) a diamine compound represented by any of the following formulas (I-1)-(I-16), or combinations thereof.

(A-1): Examples of the aliphatic diamine compounds include, but are not limited to, 1,2-diaminoethane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 4,4′-diaminoheptane, 1,3-diamino-2,2-dimethylpropane, 1,6-diamino-2,5-dimethylhexane, 1,7-diamino-2,5-dimethylheptane, 1,7-diamino-4,4-dimethylheptane, 1,7-diamino-3-methylheptane, 1,9-diamino-5-methylnonane, 2,11-diaminododecane, 1,12-diaminooctadecane, and 1,2-bis(3-aminopropoxy) ethane.

(A-2): Examples of the alicyclic diamine compounds include, but are not limited to, 4,4′-diaminodicyclohexylmethane, 4,4′-diamino-3,3′-dimethyldicyclohexylamine, 1,3-diaminocyclohexane, 1,4-diaminocyclohexane, isophoronediamine, tetrahydrodicyclopentadienylene diamine, tricyclic[6.2.1.0^{2,7}]-undecylenedimethylene diamine, and 4,4′-methylenebis(cyclohexylamine).

(A-3): Examples of the aromatic diamine compounds include, but are not limited to, 4,4′-diaminodiphenylmethane, 4,4′-diaminodiphenylethane, 4,4′-diaminodiphenylsulfone, 4,4′-diaminobenzanilide, 4,4′-diaminodiphenylether, 3,4′-diaminodiphenylether, 1,5-diaminonaphthalene, 5-amino-1-(4′-aminophenyl)-1,3,3-trimethylindane, 6-amino-1-(4′-aminophenyl)-1,3,3-trimethylindane, hexahydro-4,7-methanoindanylenedimethylene diamine, 3,3′-diaminobenzophenone, 3,4′-diaminobenzophenone, 4,4′-diaminobenzophenone, 2,2-bis[4-(4-aminophenoxy)phenyl]propane, 2,2-bis[4-(4-aminophenoxy)phenyl]sulfone, 1,4-bis(4-aminophenoxy)benzene, 1,3-bis(4-aminophenoxy)benzene, 1,3-bis(3-aminophenoxy)benzene, 9,9-bis(4-aminophenyl)-10-hydroanthracene, 9,10-bis(4-aminophenyl)anthracene, 2,7-diaminofluorene, 9,9-bis(4-aminophenyl)fluorene, 4,4′-methylene-bis(2-chloroaniline), 4,4′-(p-phenyleneisopropylidene)bisaniline, 4,4′-(m-phenyleneisopropylidene)bisaniline, 5-[4-(4-n-pentylcyclohexyl)cyclohexyl]phenylmethylene-1,3-diaminobenzene, and 1,1-bis[4-4-aminophenoxy) phenyl]-4-(4-ethylphenyl)cyclohexane.

(A-4): Examples of the fluorine-containing diamine compound include, but are not limited to, 4-(1H,1H,11H-eicosafluorodecyloxy)-1,3-diaminobenzene, 4-(1H,1H-perfluoro-butoxy)-1,3-diaminobenzene, 4-(1H,1H-perfluoro-1-heptoxy)-1,3-diaminobenzene, 4-(1H,1H-perfluoro-octoxy)-1,3-diaminobenzene, 4-(pentafluorophenoxy)-1,3-diaminobenzene, 4-(2,3,5,6-tetrafluorophenoxy)-1,3-diaminobenzene, 4-(4-perfluorophenoxy)-1,3-diaminobenzene, 4-(1H,1H,2H,2H-perfluoro-1-hexoxy)-1,3-diaminobenzene, 4-(1H,1H,2H,2H-perfluoro-1-dodecyloxy)-1,3-diaminobenzene, 2,5-diaminotrifluorotoluene, di(trifluoromethyl)diaminobenzene, diaminotetra(trifluoromethyl)benzene, diamino(pentafluoroethyl)benzene, 2,5-diamino(perfluorohexyl)benzene, 2,5-diamino(perfluorobutyl)benzene, 2,2′-bis(trifluoromethyl)-4,4′-diaminodiphenyl, octafluorodiaminodiphenyl, 3,3′-bis(trifluoromethyl)-4,4′-diaminodiphenyl, 2,2′-bis(trifluoromethyl)-4,4′-diaminodiphenyl, 2,2′-bis(p-aminophenyl)hexafluoropropane, 1,3-bis(aminophenyl)hexafluoropropane, 1,4-bis(aminophenyl)octafluorobutane, 1,5-bis(aminophenyl)decafluoropentane, 1,7-bis(aminophenyl)tetradecafluoroheptane, 2,2′-bis(trifluoromethyl)-4,4′-diaminodiphenyl ether, 3,3′-bis(trifluoromethyl)-4,4′-diaminodiphenyl ether, 3,3′,5,5′-tetra(trifluoromethyl)-4,4′-diaminodiphenylether, 3,3′-bis(trifluoromethyl)-4,4′-diaminobenzophenone, p-bis(4-amino-2-trifluorophenoxy)benzene, bis(aminophenoxy)bis(trifluoromethyl)benzene, bis(aminophenoxy)tetra(trifluoromethyl)benzene, 2,2′-bis[4-(4-aminophenoxy)phenyl]hexafluoropropane, 2,2′-bis[4-(3-aminophenoxy)phenyl]hexafluoropropane, 2,2′-bis[4-(2-aminophenoxy)phenyl]hexafluoropropane, 2,2′-bis[4-(4-aminophenoxy)-3,5-dimethylphenyl]hexafluoropropane, 2,2′-bis[4-(4-aminophenoxy)-3,5-di(trifluoromethylphenyl)]hexafluoropropane, 4,4′-bis(4-amino-2-trifluoromethylphenoxy)diphenyl, 4,4′-bis(4-amino-3-trifluoromethylphenoxy)diphenyl, 4,4′-bis(4-amino-2-trifluoromethylphenoxy)diphenylsulfone,4,4′-bis(3-amino-5-trifluoromethylphenoxy)diphenyl sulfone, 2,2′-bis[4-(4-amino-2-trifluoromethylphenoxy)phenyl]hexapropane, 2,2′-bis[4-(4-amino-3-trifluoromethylphenoxy)phenyl]hexapropane, bis[(trifluoromethyl)aminophenoxy]diphenyl, bis {[(trifluoromethyl)aminophenoxy]phenyl}hexafluoropropane, bis{[2-(aminophenoxy)phenyl]hexafluoroisopropyl}benzene, bis(2,3,5,6-tetrafluoro-4-aminophenyl)ether, bis(2,3,5,6-tetrafluoro-4-aminophenyl)sulfide, 1,3-diaminotetrafluorobenzene, 1,4-diaminotetrafluorobenzene, 4,4′-bis(tetrafluoroaminophenoxy)octafluorodiphenyl, and 4,4′-bis[(4-amino-2-trifluoromethyl)phenoxy]octafluorodiphenyl.

(A-5): the compounds represented by formulas (I-1)-(I-16):

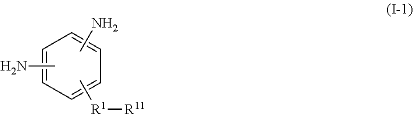

wherein R¹ represents —O—, —COO—, —COO—, —NHCO—, —CONH—, or —CO—; R¹¹ represents a monovalent group having a group selected from the group consisting of asteroid skeleton, a trifluoromethyl group, a fluoro group, a C₂-C₃₀ alkyl group, and a nitrogen-containing cyclic structure derived from pyridine, pyrimidine, triazine, piperidine and piperazine,

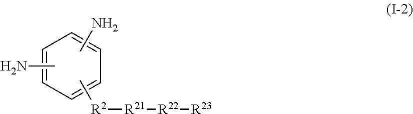

wherein R² represents —O—, —COO—, —COO—, —NHCO—, —CONH—, or —CO—; R²¹ and R²² respectively represent a divalent group selected from the group consisting of an alicyclic group, an aromatic group, and a heterocyclic group; R²³ represents a C₃-C₁₈ alkyl group, a C₃-C₁₈ alkoxy group, a C₁-C₅ fluoroalkyl group, a C₁-C₅ fluoroalkoxy group, a cyano group, or a halogen atom,

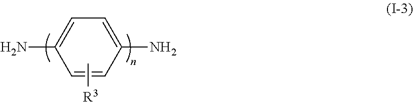

wherein R³ represents hydrogen, a C₁-C₅ acyl group, a C₁-C₅ alkyl group, a C₁-C₅ alkoxy group, or halogen; R³ in each repeating unit may be the same or different; and n is an integer ranging from 1 to 3,

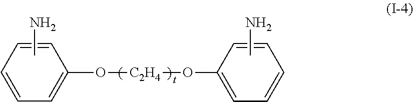

wherein t is an integer ranging from 2 to 12,

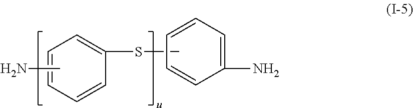

wherein u is an integer ranging from 1 to 5,

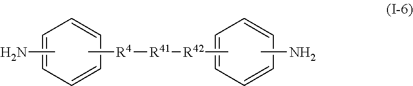

wherein R⁴ and R⁴² may be the same or different, and respectively represent a divalent organic group; and R⁴¹ represents a divalent group that has a ring structure containing a nitrogen atom and that is derived from the group consisting of pyridine, pyrimidine, triazine, piperidine and piperazine,

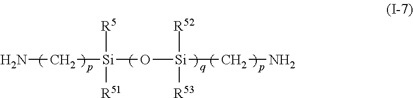

wherein R⁵, R⁵¹, R⁵², and R⁵³ may be the same or different, and respectively represent a C₁-C₁₂ hydrocarbon group; p is an integer ranging from 1 to 3; and q is an integer ranging from 1 to 20,

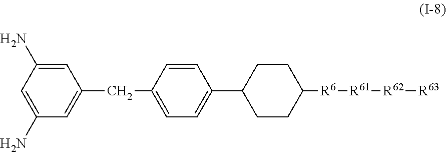

wherein R⁶ represents —O— or cyclohexylene; represents —CH₂—; R⁶² represents phenylene or cyclohexylene; and R⁶³ represents hydrogen or heptyl,

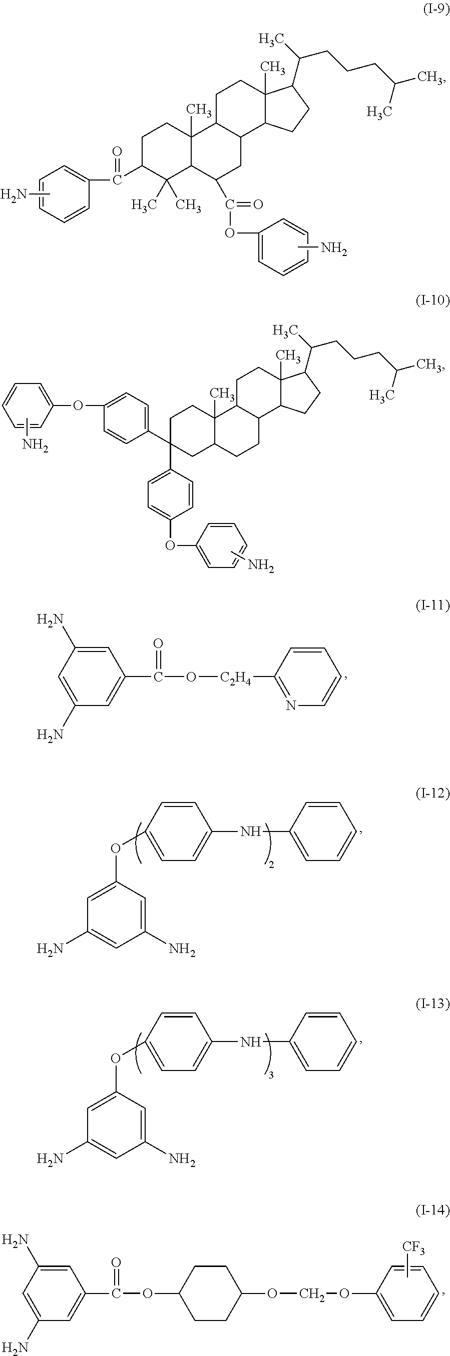

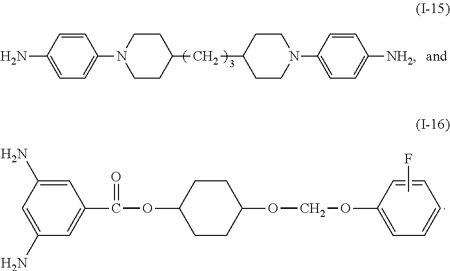

Preferred examples of the diamine compound represented by formula (I-1) include 2,4-diaminophenyl ethyl formate, 3,5-diaminophenyl ethyl formate, 2,4-diaminophenyl propyl formate, 3,5-diaminophenyl propyl formate, 1-dodecoxy-2,4-aminobenzene, 1-hexadecoxy-2,4-aminobenzene, 1-octadecoxy-2,4-aminobenzene,

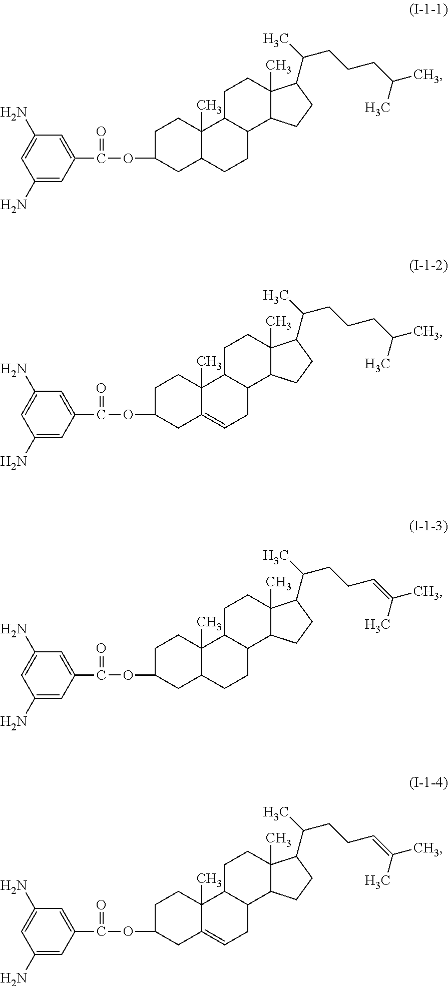 [SMILES: CC(C)CCCC(C)C1CCC2C3CCC4CC(OC(=O)c5cc(N)cc(N)c5)CCC4(C)C3CCC12C ; CC(C)CCCC(C)C1CCC2C3CC=C4CC(OC(=O)c5cc(N)cc(N)c5)CCC4(C)C3CCC12C ; CC(C)=CCCC(C)C1CCC2C3CCC4CC(OC(=O)c5cc(N)cc(N)c5)CCC4(C)C3CCC12C ; CC(C)=CCCC(C)C1CCC2C3CC=C4CC(OC(=O)c5cc(N)cc(N)c5)CCC4(C)C3CCC12C]

or the like.

Preferred examples of the diamine compound represented by formula (I-2) include

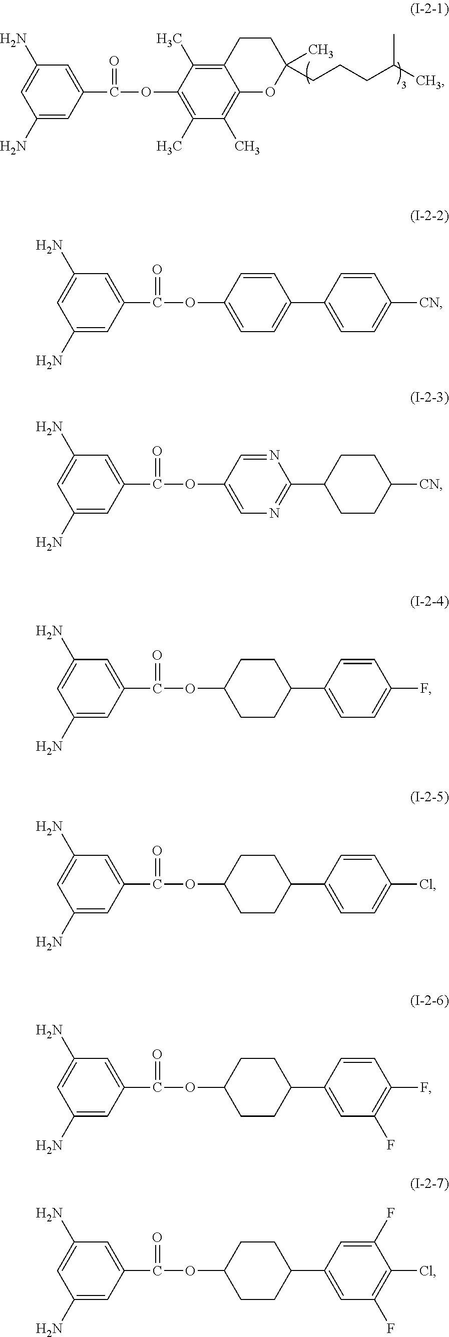

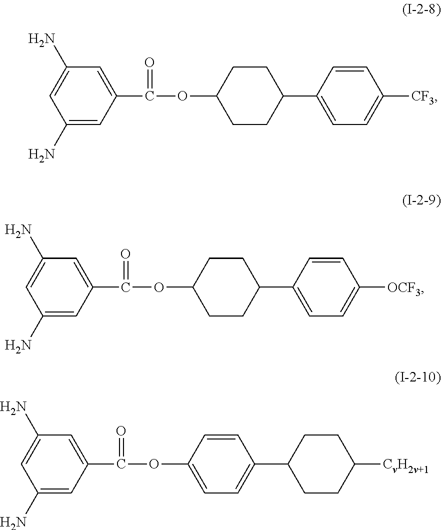

(wherein v represents an integer ranging from 3 to 12),

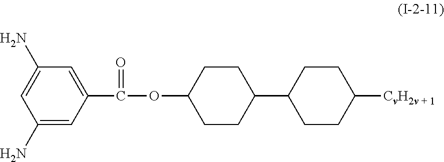

(wherein v represents an integer ranging from 3 to 12),

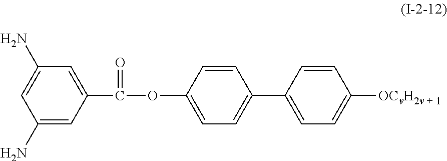

(wherein v represents an integer ranging from 3 to 12),

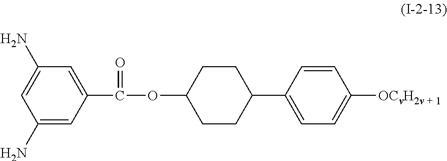

(wherein v represents an integer ranging from 3 to 12), or the like.

Preferred examples of the diamine compound represented by formula (I-3)include: (1) p-diaminobenzene, m-diaminobenzene, o-diaminobenzene, 2,5-diaminotoluene, or the like when n is 1; (2) 4,4′-diaminobiphenyl, 2,2′-dimethyl-4,4′-diaminobiphenyl, 3,3′-dimethyl-diaminobiphenyl, 2,2′-dichloro-4,4′-diaminobiphenyl, 3,3′-dichloro-4,4′-diaminobiphenyl, 2,2′,5,5′-tetrachloro-4,4′-diaminobiphenyl, 2,2′-dichloro-4,4′-diamino-5,5′-dimethoxybiphenyl, or the like when n is 2; and (3) 1,4-bis(4′-aminophenyl)benzene, or the like when n is 3. More preferably, the diamine compound represented by formula (I-3) is selected from p-diaminobenzene, 2,5-diaminotoluene, 4,4′-diaminobiphenyl, 3,3′-dimethoxy-4,4′-diaminobiphenyl, and 1,4-bis(4′-aminophenyl)benzene.

Preferably, the diamine compound represented by formula (I-5) is 4,4′-diaminodiphenylsulfide.

Preferably, the diamine compound represented by formula (I-8) is selected from

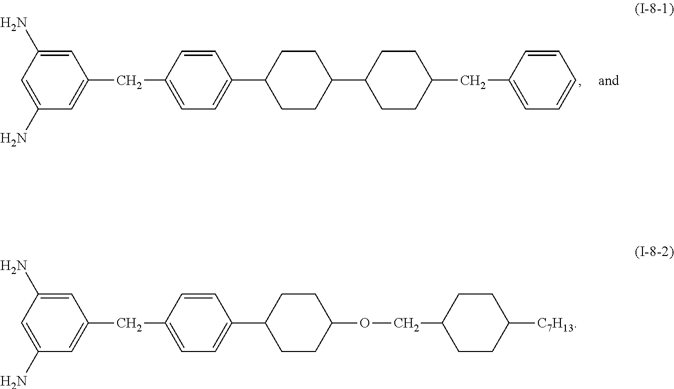

Preferred examples of the diamine component (A) suitable for the present invention include, but are not limited to, 1,2-diaminoethane, 4,4′-diaminodicyclohexyl methane, 4,4′-diaminodiphenylmethane, 4,4′-diaminodiphenylether, 5-[4-(4-n-pentylcyclohexyl)cyclohexyl]phenylmethylene-1,3-diaminobenzene, 1,1-bis[4-4-aminophenoxy)phenyl]-4-(4-ethylphenyl)cyclohexane, 2,4-diaminophenyl ethyl formate, the diamine compounds represented by formulae (I-1-1), (I-1-2), (I-2-1), and (I-2-11), p-diaminobenzene, m-diaminobenzene, o-diaminobenzene, and the diamine compound represented by formula (I-8-1).

### (B) Tetracarboxylic Dianhydride Component:

The tetracarboxylic dianhydride component (B) is selected from: (B-1) an aliphatic tetracarboxylic dianhydride compound, (B-2) an alicyclic tetracarboxylic dianhydride compound, (B-3) a fluorine-containing tetracarboxylic dianhydride compound, (B-4) an aromatic tetracarboxylic dianhydride compound, (B-5) a teracarboxylic dianhydride compound represented by the following formulas (II-1)-(II-6), and combinations thereof.

(B-1): Examples of the aliphatic tetracarboxylic dianhydride compound include, but are not limited to, ethanetetracarboxylic dianhydride and butanetetracarboxylic dianhydride.

(B-2): Examples of the alicyclic tetracarboxylic dianhydride compound include, but are not limited to, 1,2,3,4-cyclobutanetetracarboxylic dianhydride, 1,2-dimethyl-1,2,3,4-cyclobutanetetracarboxylic dianhydride, 1,3-dimethyl-1,2,3,4-cyclobutanetetracarboxylic dianhydride, 1,3-dichloro-1,2,3,4-cyclobutanetetracarboxylic dianhydride, 1,2,3,4-tetramethyl-1,2,3,4-cyclobutane tetracarboxylic dianhydride, 1,2,3,4-cyclopentane tetracarboxylic dianhydride, 1,2,4,5-cyclohexane tetracarboxylic dianhydride, 3,3′,4,4′-dicyclohexane tetracarboxylic dianhydride, cis-3,7-dibutylcycloheptyl-1,5-diene-1,2,5,6-tetracarboxylic dianhydride, 2,3,5-tricarboxylcyclopentylacetic dianhydride, and bicyclo[2.2.2]-octa-7-ene-2,3,5,6-tetracarboxylic dianhydride.

(B-3): Examples of the fluorine-containing tetracarboxylic dianhydride compound include, but are not limited to, (trifluoromethyl)pyromellitic dianhydride, bis(trifluoromethyl)pyromellitic dianhydride, bis(heptafluoropropyl)pyromellitic dianhydride, pentafluoroethylpyromellitic dianhydride, bis[3,5-di(trifluoromethyl)phenoxy]pyromellitic dianhydride, 2,2′-bis(3,4-dicarboxyphenyl)hexafluoropropane dianhydride, 5,5′-bis(trifluoromethyl)-3,3′,4,4′-biphenyl tetracarboxylic dianhydride, 2,2′,5,5′-tetra(trifluoromethyl)-3,3′,4,4′-biphenyl tetracarboxylic dianhydride, 5,5′-bis(trifluoromethyl)-3,3′,4,4′-tetracarboxylic dianhydride biphenylether, 5,5′-bis(trifluoromethyl)-3,3′,4,4′-tetracarboxylic dianhydride benzophenone, bis[(trifluoromethyl)dicarboxyphenoxy]benzene dianhydride, bis [(trifluoromethyl)dicarboxyphenoxy]trifluoromethylbenzene dianhydride, bis(dicarboxyphenoxy)trifluoromethylbenzene dianhydride, bis(dicarboxyphenoxy)bis(trifluoromethyl)benzene dianhydride, bis(dicarboxyphenoxy)tetra(trifluoromethyl)benzene dianhydride, 2,2-bis[4-(3,4-dicarboxyphenoxy)phenyl]hexafluoropropane dianhydride, bis[(trifluoromethyl)dicarboxyphenoxy]diphenyl dianhydride, bis[(trifluoromethyl)dicarboxyphenoxy]di(trifluoromethyl)diphenyl dianhydride, bis [(trifluoromethyl)dicarboxyphenoxy]diphenylether dianhydride, bis(dicarboxyphenoxy)bis(trifluoromethyl)diphenyl dianhydride, 1,3-bis(3,4-dicarboxyphenoxy)tetramethyldisiloxane dianhydride, difluoropyromellitic dianhydride, 1,4-bis(3,4-dicarboxytrifluorophenoxy)tetrafluorobenzene dianhydride, and 1,4-bis(3,4-dicarboxytrifluorophenoxy)octafluorodiphenyl dianhydride.

(B-4): Examples of the aromatic tetracarboxylic dianhydride compound include, but are not limited to, 3,4-dicarboxy-1,2,3,4-tetrahydronaphthalene-1-succinic acid dianhydride, pyromellitic dianhydride, 3,3′,4,4′-benzophenonetetracarboxylic dianhydride, 3,3′,4,4′-biphenylsulfonetetracarboxylic dianhydride, 1,4,5,8-naphthalenetetracarboxylic dianhydride, 2,3,6,7-naphthalenetetracarboxylic dianhydride, 3,3′-4,4′-biphenylethanetetracarboxylic dianhydride, 3,3′,4,4′-dimethyldiphenylsilanetetracarboxylic dianhydride, 3,3′,4,4′-tetraphenylsilanetetracarboxylic dianhydride, 1,2,3,4-furantetracarboxylicdianhydride, 4,4′-bis(3,4-dicarboxyphenoxy)diphenylsulfide dianhydride, 4,4′-bis(3,4-dicarboxyphenoxy)diphenylsulfone dianhydride, 4,4′-bis(3,4-dicarboxyphenoxy)diphenylpropane dianhydride, 3,3′,4,4′-diphenyltetracarboxylic dianhydride, bis(phthalic acid)phenylphosphine oxide dianhydride, p-phenylene-bis(triphenylphthalic acid) dianhydride, m-phenylene-bis(triphenylphthalic acid) dianhydride, bis(triphenylphthalic acid)-4,4′-diphenyl ether dianhydride, bis(triphenylphthalic acid)-4,4′-diphenylmethane dianhydride, ethylene glycol-bis(anhydrotrimellitate), propylene glycol-bis(anhydrotrimellitate), 1,4-butanediol-bis(anhydrotrimellitate), 1,6-hexanediol-bis(anhydrotrimellitate), 1,8-octanediol-bis(anhydrotrimellitate), 2,2-bis(4-hydroxyphenyl)propane-bis(anhydrotrimellitate), 2,3,4,5-tetrahydrofurantetracarboxylic dianhydride, 1,3,3a,4,5,9b-hexahydro-5-(tetrahydro-2,5-dioxo-3-furanyl)-naphtho[1,2-c]-furan-1,3-dione, 1,3,3a,4,5,9b-hexahydro-5-methyl-5-(tetrahydro-2,5-dioxo-3-furanyl)-naphtho[1,2-c]-furan-1,3-dione, 1,3,3a,4,5,9b-hexahydro-5-ethyl-5-(tetrahydro-2,5-dioxo-3-furanyl)naphtho[1,2-c]-furan-1,3-dione, 1,3,3a,4,5,9b-hexahydro-7-methyl-5-(tetrahydro-2,5-dioxo-3-furanyl)-naphtho[1,2-c]-furan-1,3,-dione, 1,3,3a,4,5,9b-hexahydro-7-ethyl-5-(tetrahydro-2,5-dioxo-3-furanyl)naphtho[1,2-c]-furan-1,3,-dione, 1,3,3a,4,5,9b-hexahydro-8-methyl-5-(tetrahydro-2,5-dioxo-3-furanyl)-naphtho[1,2-c]-furan-1,3-dione, 1,3,3a,4,5,9b-hexahydro-8-ethyl-5-(tetrahydro-2,5-dioxo-3-furanyl)naphtho[1,2-c]-furan-1,3-dione, 1,3,3a,4,5,9b-hexahydro-5,8-dimethyl-5-(tetrahydro-2,5-dioxo-3-furanyl)-naphtho[1,2-c]-furan-1,3-dione, and 5-(2,5-dioxotetrahydrofuranyl)-3-methyl-3-cyclohexene-1,2-dicarboxylic dianhydride.

(B-5): The teracarboxylic dianhydride compounds represented by the following formulas (II-1)-(II-6):

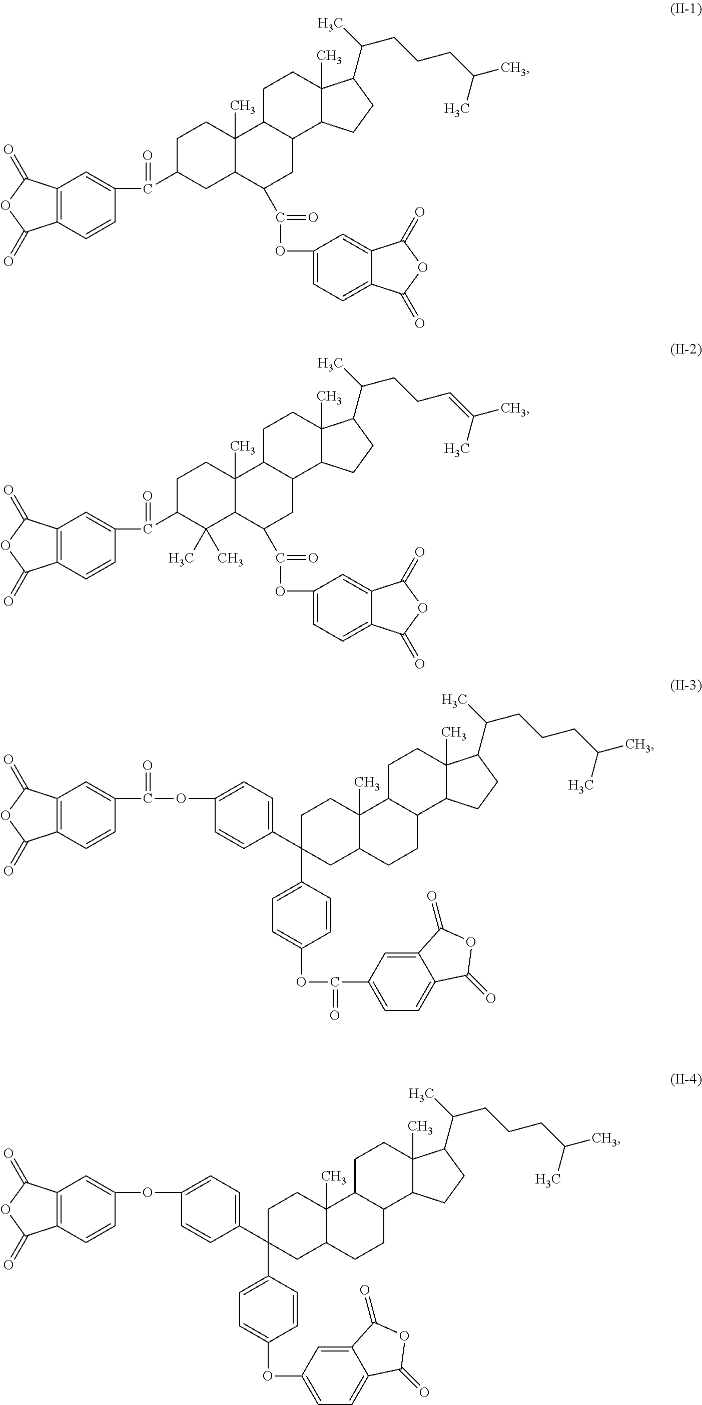

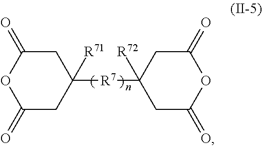

wherein R⁷ represents a divalent group having an aromatic ring structure; n represents an integer ranging from 1 to 2; and R⁷¹ and R⁷² may be the same or different, and independently represent hydrogen or an alkyl group, and

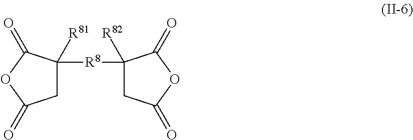

wherein R⁸ represents a divalent group having an aromatic ring structure; and R⁸¹ and R⁸² may be the same or different, and independently represent hydrogen or an alkyl group.

Preferably, the tetracarboxylic dianhydride compound represented by formula (II-5) is selected from

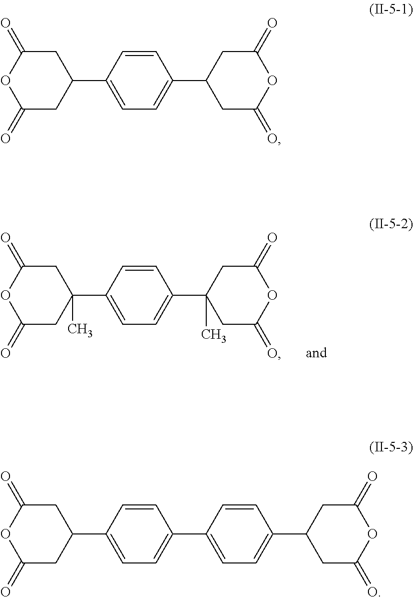 [SMILES: O=C1CC(c2ccc(C3CC(=O)OC(=O)C3)cc2)CC(=O)O1 ; CC1(c2ccc(C3(C)CC(=O)OC(=O)C3)cc2)CC(=O)OC(=O)C1 ; O=C1CC(c2ccc(-c3ccc(C4CC(=O)OC(=O)C4)cc3)cc2)CC(=O)O1]

Preferably, the tetracarboxylic dianhydride compound represented by formula (II-6) is

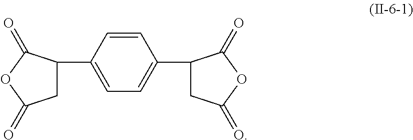 [SMILES: O=C1CC(c2ccc(C3CC(=O)OC3=O)cc2)C(=O)O1]

Preferred examples of the tetracarboxylic dianhydride component (B) suitable for the present invention include, but are not limited to, ethanetetracarboxylic dianhydride, butanetetracarboxylic dianhydride, 1,2,3,4-cyclobutane tetracarboxylic dianhydride, 1,3-dichloro-1,2,3,4-cyclobutanetetracarboxylic dianhydride, 1,2,3,4-cyclopentanetetracarboxylic dianhydride, 2,3,5-tricarboxycyclopentylacetic dianhydride, 1,2,4,5-cyclohexanetetracarboxylic dianhydride, 3,3′,4,4′-dicyclohexanetetracarboxylic dianhydride, bicyclo[2.2.2]-octa-7-ene-2,3,5,6-tetracarboxylic dianhydride, (trifluoromethyl)pyromellitic dianhydride, bis(trifluoromethyl)pyromelliticdianhydride, pentafluoroethyl pyromellitic dianhydride, bis(dicarboxyphenoxy)tetra(trifluoromethyl)benzene dianhydride, bis[(trifluoromethyl)dicarboxyphenoxy]diphenyl dianhydride, bis [(trifluoromethyl)dicarboxyphenoxy]diphenylether dianhydride, and 1,4-bis(3,4-dicarboxytrifluorophenoxy)tetrafluorobenzene dianhydride.

The polymer component included in the polymer composition for making the release layer includes a polyamic acid compound, a polyimide compound, a polyimide series block copolymer, or combinations thereof.

### Polyamic Acid Compound:

The polyamic acid compound is obtained by subjecting the aforesaid diamine component (A) and the aforesaid tetracarboxylic dianhydride component (B) to a polycondensation reaction. The polycondensation reaction between the diamine component (A) and the tetracarboxylic dianhydride component (B) is conducted in a solvent at a temperature ranging from 0 to 100° C. for a period ranging from 1 to 24 hours to obtain a reaction solution containing the obtained polymer. The reaction solution is distillated under a reduced pressure in a distiller to obtain the polyamic acid compound. Alternatively, the reaction solution can be treated by pouring it into a large amount of poor solvent to obtain a precipitate, which is then dried under a reduced pressure to obtain the polyamic acid compound.

The tetracarboxylic dianhydride component (B) is used in an amount ranging preferably from 20 to 200 moles, more preferably from 30 to 120 moles based on 100 moles of the diamine component (A).

The solvent for the polycondensation reaction may be the same as or different from the organic solvent used in the polymer composition for making the release layer. Furthermore, there is no particular limitation to the solvent for the polycondensation reaction as long as the solvent is able to dissolve the reactants and the products. Examples of the solvent for the polycondensation reaction include, but are not limited to, (1) aprotic polar solvents, such as 1-methyl-2-pyrrolidone, N,N-dimethylacetamide, N,N-dimethylformamide, dimethylsulfoxide, γ-butyrolactone, tetramethylurea, hexamethylphosphoric acid triamide, and the like; and (2) phenolic solvents, such as m-cresol, xylenol, phenol, halogenated phenols, and the like.

The solvent for the polycondensation reaction is used in an amount preferably from 200 to 2,000 parts by weight, and more preferably from 300 to 1,800 parts by weight, based on 100 parts by weight of a combination of the diamine component (A) and the tetracarboxylic dianhydride component (B).

The aforementioned solvent for the polycondensation reaction can be used in combination with a poor solvent in such an amount that does not cause precipitation of the formed polymer. Examples of the poor solvent include, but are not limited to, (1) alcohols, such as methyl alcohol, ethyl alcohol, isopropyl alcohol, cyclohexanol, ethylene glycol, propylene glycol, 1,4-butanediol, triethylene glycol, or the like; (2) ketones, such as acetone, methyl ethyl ketone, methyl isobutyl ketone, cyclohexanone, or the like; (3) esters, such as methyl acetate, ethyl acetate, butyl acetate, diethyl oxalate, diethyl malonate, ethylene glycol ethyl ether acetate, or the like; (4) ethers, such as diethyl ether, ethylene glycol methyl ether, ethylene glycol ethyl ether, ethylene glycol n-propyl ether, ethylene glycol i-propyl ether, ethylene glycol n-butyl ether, ethylene glycol dimethyl ether, diethylene glycol dimethyl ether, or the like; (5) halogenated hydrocarbons, such as dichloromethane, 1,2-dichloroethane, 1,4-dichlorobutane, trichloroethane, chlorobenzene, o-dichlorobenzene, or the like; and (6) hydrocarbons, such as tetrahydrofuran, hexane, heptane, octane, benzene, toluene, xylene, or the like; or combinations thereof. The examples of the poor solvent may be used alone or in admixture of two or more.

The poor solvent is used in an amount preferably from 0 to 60 parts by weight, and more preferably from 0 to 50 parts by weight, based on 100 parts by weight of the diamine component (A).

### Polyimide Compound:

The polyimide compound useful in the present invention is obtained by subjecting the aforesaid diamine component (A) and the aforesaid tetracarboxylic dianhydride component (B) to a polymerization reaction or by further dehydration/ring-closure (imidization)processing of the aforesaid polyamic acid compound to transfer the amic acid functional group of the polyamic acid compound into the imido functional group.

The imidization processing of the polyamic acid compound is conducted by, for example, dissolving the polyamic acid compound in a solvent, and heating in the presence of a dehydrating agent and an imidization catalyst to implement the dehydration/ring-closing (imidization) reaction.

The polyamic acid compound useful for preparing the polyimide compound and the preparation method thereof are the same as the aforesaid polyamic acid compound and the preparation method thereof. The solvent for the imidization processing may be the same as the organic solvent used in the polymer composition for making the release layer. The solvent for the imidization processing is used in an amount preferably from 200 to 2,000 parts by weight, and more preferably from 300 to 1,800 parts by weight based on 100 parts by weight of the polyamic acid compound.

Heating temperature for the imidization processing is generally from 40° C. to 250° C. and preferably from 40° C. to 150° C. If the reaction temperature of the imidization processing is lower than 40° C., then the dehydration ring-closing reaction cannot be fully implemented and the imidization extent is unsatisfactorily low. If the reaction temperature exceeds 250° C., then the weight average molecular weight of the obtained polyimide compound is undesirably low.

Examples of the dehydrating agent suitable for the imidization processing include acid anhydride compounds, such as acetic anhydride, propionic anhydride, trifluoroacetic anhydride, and the like. The used amount of the dehydrating agent is preferably from 0.01 to 20 moles per mole of the polyamic acid compound. Examples of the catalyst suitable for the imidization processing include pyridine compounds, such as pyridine, trimethyl pyridine, dimethylpyridine, or the like; and tertiary amines, such as triethylamine, or the like. The used amount of the catalyst is preferably from 0.5 to 10 moles per mole of the dehydrating agent.

### Polyimide Series Block Copolymer:

The polyimide series block copolymer suitable for the present invention is selected from polyamic acid block copolymer, polyimide block copolymer, polyamic acid-polyimide block copolymer, or combinations thereof.

In the synthesis reaction of the polyimide series block copolymer, the polyimide series block copolymer is obtained by further polycondensation reaction of a starting material including the polyamic acid compound and/or the polyimide compound, and further the diamine component and/or the tetracarboxylic dianhydride component in a solvent. The diamine component and the tetracarboxylic dianhydride component used for the synthesis reaction of the polyimide series block copolymer may be the same as the diamine component and the tetracarboxylic dianhydride component used for the preparation of the polyamic acid compound, and the solvent used for the synthesis reaction of the polyimide series block copolymer may be the same as the organic solvent used in the polymer composition for making the release layer. The solvent for the synthesis reaction of the polyimide series block copolymer is used in an amount preferably from 200 to 2,000 parts by weight and more preferably from 300 to 1,800 parts by weight based on 100 parts by weight of the starting material for synthesis reaction of the polyimide series block copolymer.

In the polycondensation reaction for the polyimide series block copolymer, the reaction temperature is generally from 0 to 200° C. and preferably from 0 to 100° C.

Preferably, non-limiting examples of the starting material used for the synthesis reaction of the polyimide series block copolymer include: (1) first and second polyamic acids which are different from each other in structures and terminal groups thereof; (2) first and second polyimides which are different from each other in structures and terminal groups thereof; (3) a polyamic acid and a polyimide which are different from each other in structures and terminal groups thereof; (4) a polyamic acid, a diamine compound, and a tetracarboxylic dianhydride compound, wherein at least one of the diamine compound and the tetracarboxylic dianhydride compound is structurally different from the one used in the reaction for preparing the polyamic acid; (5) a polyimide, a diamine compound, and a tetracarboxylic dianhydride compound, wherein at least one of the diamine compound and the tetracarboxylic dianhydride compound is structurally different from the one used in the reaction for preparing the polyimide; (6) a polyamic acid, a polyimide, a diamine compound, and a tetracarboxylic dianhydride compound, wherein at least one of the diamine compound and the tetracarboxylic dianhydride compound is structurally different from the ones used in the reaction for preparing the polyamic acid and the reaction for preparing the polyimide; (7) first and second polyamic acids, a diamine compound, and a tetracarboxylic dianhydride compound, wherein the first and second polyamic acids are structurally different from each other; (8) first and second polyimides, a diamine compound, and a tetracarboxylic dianhydride compound, wherein the first and second polyimides are structurally different from each other; (9) first and second polyamic acids and a diamine compound, wherein the first and second polyamic acids have anhydride terminal groups and are structurally different from each other; (10) first and second polyamic acids and a tetracarboxylic dianhydride compound, wherein the first and second polyamic acids have amino terminal groups and are structurally different from each other; (11) first and second polyimides and a diamine compound, wherein the first and second polyimides have anhydride terminal groups and are structurally different from each other; and (12) first and second polyimides and a tetracarboxylic dianhydride compound, wherein the first and second polyimides have amino terminal groups and are structurally different from each other.

Additionally, the polyamic acid compound, the polyimide compound, and the polyimide series block copolymer used in the present invention can also be the polymers which are terminal-modified after an adjustment of molecular weight thereof. The terminal-modified polymers can be used to improve the coating property and the like of the polymer composition for making the release layer as long as they will not reduce the desirable effects of the present invention.

The process for synthesizing the terminal-modified polymers involves adding monofunctional compounds to the reaction system during the polycondensation reaction for the polyamic acid. Examples of the monofunctional compounds include, but are not limited to, (1) monoanhydride compounds, such as maleic anhydride, phthalic anhydride, itaconic anhydride, n-decyl succinic anhydride, n-dodecyl succinic anhydride, n-tetradecyl succinic anhydride, n-hexadecyl succinic anhydride, and the like; (2) monoamine compounds, such as aniline, cyclohexylamine, n-butylamine, n-amylamine, n-hexylamine, n-heptylamine, n-octylamine, n-nonylamine, n-decylamine, n-undecylamine, n-dodecylamine, n-tridecylamine, n-tetradecylamine, n-pentadecylamine, n-hexadecylamine, n-heptadecylamine, n-octadecylamine, n-eicosylamine, and the like; and (3) monoisocyanate compounds, such as phenyl isocyanate, naphthylisocyanate, and the like.

### Polymer Composition:

In addition to the aforesaid polymer component, the polymer composition for making the release layer includes an organic solvent for dispersing the polymer component.

Preferably, the organic solvent is selected from 1-methyl-2-pyrrolidone, γ-butyrolactone, γ-butyrolactam, 4-hydroxy-4-methyl-2-pentanone, ethylene glycol monomethyl ether, butyl lactate, butyl acetate, methyl methoxypropionate, ethyl ethoxypropionate, ethylene glycol methyl ether, ethylene glycol ethyl ether, ethylene glycol n-propyl ether, ethylene glycol isopropyl ether, ethylene glycol n-butyl ether, ethylene glycol dimethyl ether, ethylene glycol ethyl ether acetate, diglycol dimethyl ether, diglycol diethyl ether, diglycol monomethyl ether, diglycol monoethyl ether, diglycol monomethyl ether acetate, diglycol monoethyl ether acetate, N,N-dimethylformamide, or N,N-dimethylethanamide. The examples of the organic solvent may be used alone or in admixture of two or more.

The solvent for the synthesis reaction of the polyimide series block copolymer is used in an amount preferably from 200 to 2,000 parts by weight and more preferably from 300 to 1,800 parts by weight based on 100 parts by weight of the starting material for synthesis reaction of the polyimide series block copolymer.

The organic solvent used in the polymer composition for making the release layer is in an amount preferably from 600 to 2,000 parts by weight based on 100 parts by weight of the polymer component.

Preferably, silicon particles are included in the polymer composition. The mean particle size of the silicon particles ranges generally from 0.1 nm to 10 μm, preferably from 1 nm to 5 μm, and more preferably from 10 nm to 1 μm. When the mean particle size of the silicon particles ranges from 0.1 nm to 10 μm, the release layer thus formed has superior transparency.

The silicon particles are in an amount preferably from 0.1 to 10 parts by weight, more preferably from 0.3 to 8 parts by weight, and most preferably from 0.5 to 5 parts by weight based on 100 parts by weight of the polymer component. When silicon particles are in an amount preferably from 0.1 to 10 parts by weight, the release layer thus formed has good rework property.

Examples of the silicon particles include commercially available products manufactured by Evonik, for example, Aerosil R972, Aerosil R974, Aerosil R976, or the like; commercially available products manufactured by Admatechs, for example, SE-1050, SE-2050, SC-2050, SO-E1, SO-C1, SO-C2, SO-C3, SO-05, SO-E2, SOEE3, SO-E5, or the like; commercially available products manufactured by Shin-Etsu Chemical Co., Ltd., for example, Musi1120A, Musi1130A, or the like; commercially available products manufactured by Catalysts and Chemicals Ltd., for example, OSCAR 1132 (particle size: 12 nm, dispersant:methanol), OSCAR 1332 (particle size: 12 nm, dispersant: n-propanol), OSCAR 105 (particle size: 60 nm, dispersant: γ-butyrolactone), OSCAR 106 (particle size: 120 nm, dispersant: diacetone alcohol), or the like; commercially available products manufactured by Fuso Chemical Co., Ltd., for example, Quartron PL-1-IPA (particle size: 13 nm, dispersant: isopropanone), Quartron PL-1-TOL (particle size: 13 nm, dispersant:toluene), Quartron PL-2L-PGME (particle size: 18 nm, dispersant: propylene glycol monomethyl ether), Quartron PL-2L-MEK (particle size: 18 nm, dispersant: methyl ethyl ketone), or the like; commercially available products manufactured by Nissan Chemical, for example, IPA-ST (particle size: 12 nm, dispersant: isopropanol), EG-ST (particle size: 12 nm, dispersant: ethylene glycol), IPA-ST-L (particle size: 45 nm, dispersant: isopropanol), IPA-ST-ZL (particle size: 100 nm, dispersant: isopropanol), or the like; and commercially available products manufactured by Shin-Etsu Chemical Co., Ltd., for example, KMP-600, KMP-605, X-52-7030 (particle size: 0.7 μm). The aforesaid silicon dioxide particles can be used alone or as a mixture of two or more.

Silane compound can be included in the polymer composition for making the release layer as long as the effects of the present invention are not undesirably affected. Examples of the silane compound include, but are not limited to, 3-aminopropyltrimethoxysilane, 3-aminopropyltriethoxysilane, 2-aminopropyltrimethoxy silane, 2-aminopropyltriethoxysilane, N-(2-aminoethyl)-3-aminopropyltrimethoxysilane, N-(2-aminoethyl)-3-aminopropylmethyldimethoxysilane, 3-ureidopropyltrimethoxysilane, 3-ureidopropyltriethoxysilane, N-ethoxycarbonyl-3-aminopropyltrimethoxysilane, N-ethoxycarbonyl-3-aminopropyltriethoxysilane, N-triethoxypropyl triethylenetriaminosilane, N-trimethoxypropyl triethylenetriaminosilane, 10-trimethoxysilyl-1,4,7-triazadecane, 10-triethoxysilyl-1,4,7-triazadecane, 9-trimethoxysilyl-3,6-diazanonylacetate, 9-triethoxysilyl-3,6-diazanonylacetate, N-benzyl-3-aminopropyltrimethoxysilane, N-benzyl-3-aminopropyltriethoxysilane, N-phenyl-3-aminopropyltrimethoxy silane, N-phenyl-3-aminopropylethoxysilane, N-bis(ethylene oxide)-3-aminopropyltrimethoxysilane, and N-bis(ethylene oxide)-3-aminopropyltriethoxysilane.

The silane compound is used in an amount preferably from 0.5 to 50 parts by weight and more preferably from 1 to 45 parts by weight based on 100 parts by weight of the polymer component.

### Preparation of the Polymer Composition and the Release Layer:

There is no specific limitation to the method for preparing the polymer composition of the present invention. The general mixing method can be used. For example, the polymer composition of the present invention can be made by forming a polymer mixture including at least one polyamic acid compound, at least one polyimide compound, at least one polyimide series block copolymer, or combinations thereof, which is then added with an organic solvent and optional additives such as silicon particles and/or silane compound at a temperature ranging from 0 to 200° C. followed by stirring until the polymer mixture is homogeneously dissolved or dispersed in the organic solvent.

The prepared polymer composition is applied to a substrate by a roller coating method, a spinner coating method, a printing method, an ink-jet method, or the like to form a coating film. The coating film is then treated by a pre-bake treatment and a post-bake treatment to obtain the release layer.

The pre-bake treatment causes the organic solvent to volatilize. Temperature for the pre-bake treatment is preferably from 30° C. to 120° C., more preferably from 40° C. to 110° C., and most preferably from 50° C. to 100° C.

The post-bake treatment is carried out to conduct a dehydration/ring-closure (imidization) reaction of the polymer component contained in the coating film after the pre-bake treatment. Temperature for the post-bake treatment is preferably from 150° C. to 300° C., more preferably from 180° C. to 280° C., and most preferably from 200° C. and 250° C.

### Flexible Substrate:

The material for making the flexible substrate includes a first component selected from polyimide, polycarbonate, polyethersulfone, polyacrylate, polynorbornene, polyethylene terephthalate, polyetheretherketone, polyethylene naphthalate, polyetherimide, or combinations thereof.

Preferably, the material for making the flexible substrate further includes a second component selected from a siloxane compound, silicon dioxide, or a combination thereof.

### Support:

The support is made of a material such as alkali-free glass, soda-lime glass, hard glass (Pyrex glass), quartz glass, silicon wafer, or the like commonly used in liquid crystal display devices.

### Substrate Structure and Preparation Thereof:

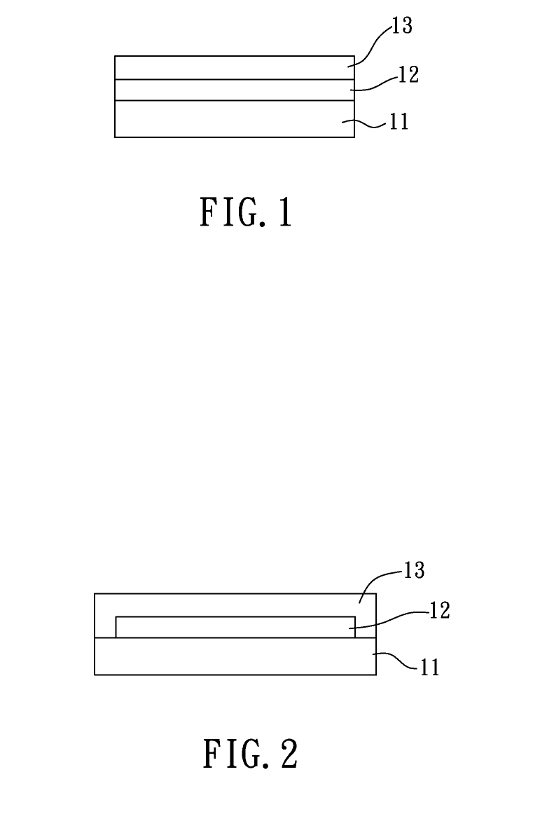

Referring to FIG. 1, a first preferred embodiment of a substrate structure according to this invention includes a support 11, a release layer 12 releasably disposed on the support 11, and a flexible substrate 13 disposed on the release layer 12.

Referring to FIG. 2, a second preferred embodiment of a substrate structure according to this invention includes the support 11, the release layer 12 releasably disposed on the support 11, and the flexible substrate 13 extending from the support 11 and covering the release layer 12.

A method for making a substrate structure of the present invention includes the steps of: forming a release layer on a support; and forming a flexible substrate on the release layer. The release layer is made from the aforesaid polymer composition.

Preferably, the release layer is formed on the support by coating, and the flexible substrate is formed on the release layer by coating.

Preferably, the method for making a substrate structure of the present invention further includes a step of stripping the flexible substrate together with the release layer from the support.

Preferably, the flexible substrate covers the release layer and the support by coating.

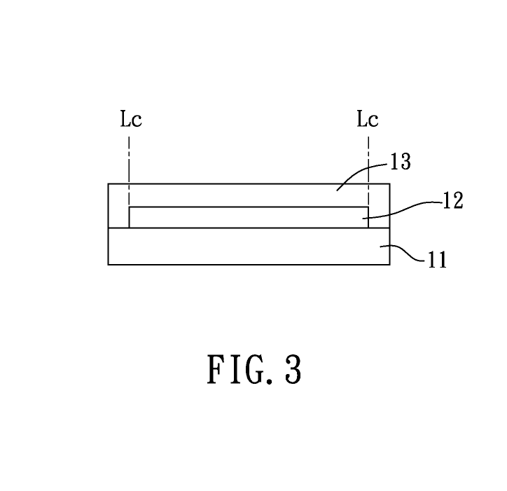

Referring to FIG. 3, when the flexible substrate 13 covers the release layer 12 and the support 11, the method for making a substrate structure of the present invention further includes a step of cutting the flexible substrate disposed on the support so that the flexible substrate only covers the release layer. For example, a cutting line (L_{c) can be aligned with the edge of the release layer or can be deviated inward from the edge of the release layer. The method for making a substrate structure of the present invention further includes a step of stripping the flexible substrate together with the release layer from the support after the cutting step.}

### EXAMPLES

The following examples are provided to illustrate the preferred embodiments of the invention, and should not be construed as limiting the scope of the invention.

### [Preparation of Polymer Component]:

### Synthesis Example 1

A 500 ml four-necked conical flask equipped with a nitrogen inlet, a stirrer, a condenser and a thermometer was purged with nitrogen, and was added with 4,4′-diaminodiphenylmethane (9.91 g, 0.05 mole), butanetetracarboxylic dianhydride (0.98 g, 0.005 mole), and 1-methyl-2-pyrrolidone (80 g). Stirring was conducted at room temperature until butanetetracarboxylic dianhydride and 4,4′-diaminodiphenylmethane were dissolved.3,4-dicarboxy-1,2,3,4-tetrahydronaphthalene-1-succinic acid dianhydride (13.51 g, 0.045 mole) and 1-methyl-2-pyrrolidone (20 g) were then added, and reaction was conducted for 6 hours at room temperature. 1-methyl-2-pyrrolidone (97 g), acetic anhydride (5.61 g), and pyridine (19.75 g) were then added. Stirring was continued for 2 hours at 190° C. to conduct imidization reaction. The reaction solution was then poured into water (1500 ml) to precipitate a polymer. The polymer obtained after filtering was washed with methanol and filtered three times, and was dried in a vacuum oven at 60° C. to obtain a polymer component (R-1).

### Synthesis Examples 2 to 10

Polymer components (R-2-R-10) were prepared according to the method of Synthesis Example 1 except that the diamine compounds, the tetracarboxylic dianhydride compounds, the amounts thereof, and the reaction conditions shown in Table 1 were used.

TABLE 1

| | | Synthesis Examples | | | | | | | | | |
|---|---|---|---|---|---|---|---|---|---|---|---|
| | | 1 | 2 | 3 | 4 | 5 | 6 | 7 | 8 | 9 | 10 |
| Components (mole %) | | R-1 | R-2 | R-3 | R-4 | R-5 | R-6 | R-7 | R-8 | R-9 | R-10 |
| Diamine | A-1 | 100 | 100 | 80 | — | 100 | — | 70 | — | — | 90 |
| Compounds (A) | A-2 | — | — | — | 100 | — | 100 | — | — | 60 | — |
| | A-3 | — | — | 20 | — | — | — | 30 | 100 | 40 | 10 |
| tetra-carboxylic | B-1-1 | — | 10 | — | — | — | 20 | — | — | 70 | |
| dianhydride | B-1-2 | 10 | — | 40 | 10 | — | — | — | — | — | 60 |
| compounds (B) | B-2-1 | — | — | — | | 30 | — | 50 | 10 | — | 40 |
| | B-2-2 | — | 10 | — | 20 | — | — | 30 | 15 | — | — |
| | B-3-1 | — | — | — | 20 | — | — | — | — | 20 | — |
| | B-3-2 | — | — | — | — | — | 45 | — | — | — | — |
| | B-4-1 | 90 | — | 30 | 50 | — | 35 | 20 | 75 | — | — |
| | B-4-2 | — | 80 | 30 | — | 70 | — | — | — | 10 | — |
| [(B − 1) + (B − 2) + (B − 3)/B * 100 | | 10 | 20 | 40 | 50 | 30 | 65 | 80 | 25 | 90 | 100 |
| dehydration ring- | Temperature (° C.) | 190 | 220 | 200 | 220 | 230 | 180 | 250 | 240 | 190 | 240 |
| closing reaction | Time (Hours) | 20 | 30 | 20 | 25 | 20 | 20 | 20 | 20 | 15 | 25 |

| | | | | | | | | | | |
|---|---|---|---|---|---|---|---|---|---|---|
| Imidization extent (%) | 50 | 62 | 55 | 68 | 66 | 46 | 75 | 70 | 48 | 71 |

Notes:
A-1: 4,4′-diaminodiphenylmethane;
A-2: 4,4′-diaminodiphenylether;
A-3: p-diaminobenzene;
B-1-1: ethanetetracarboxylic dianhydride;
B-1-2: butanetetracarboxylic dianhydride;
B-2-1: 1,2,3,4-cyclobutanetetracarboxylic dianhydride;
B-2-2: 2,3,5-tricarboxylcyclopentylacetic dianhydride;
B-3-1: (trifluoromethyl) pyromellitic dianhydride;
B-3-2: bis (trifluoromethyl) pyromellitic dianhydride;
B-4-1: 3,4-dicarboxy-1,2,3,4-tetrahydronaphthalene-1-succinic acid dianhydride;
B-4-2: 3,3′-4,4′-biphenylethanetetracarboxylic dianhydride.

### [Preparation of Substrate Structure]

### Example 1

100 parts by weight of the polymer component (R-1) of Synthesis Example 1, 725 parts by weight of 1-methyl-2-pyrrolidone, and 725 parts by weight of ethylene glycol n-butyl ether were stirred at room temperature to form a polymer composition.

The polymer composition was coated onto a glass support using a coating machine (manufactured by Japan Nissha Printing Co., Ltd., Model S15-036), after which the glass support coated with the polymer composition was pre-baked on a heating plate at a temperature of 100° C. for 3 minutes, and was then post-baked in a hot air circulation baking oven at a temperature of 250° C. for 30 minutes to form a release layer on the glass support.

A polyimide solution (TM11, manufactured by Taimide Technology Inc., solid content: 15 wt %) was then coated onto the release layer using the aforesaid coating machine, followed by pre-baking in a baking oven at a temperature of 100° C. for 10 minutes, and then post-baking at a temperature of 250° C. for 0.5 hour to form a flexible substrate on the release layer so as to obtain a substrate structure.

The substrate structure thus obtained was evaluated according to the following evaluation methods. The results are shown in Table 2.

### Examples 2-10

Examples 2-10 were conducted in a manner identical to Example 1 using the polymer components, the organic solvents, and the additives shown in Table 2 to prepare the substrate structures. The substrate structures thus obtained were evaluated according to the following evaluation methods. The results are shown in Table 2.

### [Evaluation Items]

### 1. Imidization Extent:

Imidization extent refers to a ratio of the number of the imide ring to a total of the number of the amic acid functional group and the number of the imide ring in polyimide polymer, and is expressed in percentage.

Each of the Polymer components obtained in Synthesis Examples 1-10 was dried under a reduced pressure, and was then dissolved in a proper deuteration solvent, for example, deuterated dimethylsulfoxide. ¹H-NMR determination was conducted at room temperature (for example, 25° C.) using tetramethylsilane as a standard. The imidization extent (in %) was calculated using the following formula:

Imidization extent (in %)=(1−Δ1/(Δ2×α))×100

wherein

Δ1 is a peak area produced by a chemical shift around 10 ppm of the proton of NH group;

Δ2 is a peak area of the proton other than that of NH group; and

α is a ratio of the number of the proton of NH group to the number of the proton other than that of NH group in a precursor of polyimide polymer (i.e., polyamic acid polymer).

### 2. Release Property:

Each of the release layers obtained in Examples 1-10 was cut into an array of squares using a cross-cut tester. An adhesive tape was then adhered onto the array of squares for 5 seconds, and stripped from the array. The number of the squares that remained on the support was counted, and a remaining ratio was calculated by dividing the number of the remaining squares by the total number of the array of squares. Evaluation was conducted according to the following standards:

⊚: the remaining ratio<10%:

◯: 20%>the remaining ratio≧10%;

X: the remaining ratio≧20%.

### 3. Transparency:

Transmittance of each of the release layers obtained in Examples 1-10 was measured using a spectrophotometer (Model No. U-3310, manufactured by Hitachi) at a wavelength ranging from 380 nm to 780 nm. The transparency of each of the release layers was evaluated by an average transmittance.

◯: Average transmittance>95%;

X: Average transmittance≦95%.

TABLE 2

| | | Examples | | | | | | | | | |
|---|---|---|---|---|---|---|---|---|---|---|---|
| Components (Parts by weight) | | 1 | 2 | 3 | 4 | 5 | 6 | 7 | 8 | 9 | 10 |
| Polymer Components | R-1 | 100 | — | — | — | — | — | — | — | — | — |
| | R-2 | — | 100 | — | — | — | — | — | — | — | — |
| | R-3 | — | — | 100 | — | — | — | — | — | — | — |
| | R-4 | — | — | — | 100 | — | — | — | — | — | — |
| | R-5 | — | — | — | — | 100 | — | — | — | — | — |
| | R-6 | — | — | — | — | — | 100 | — | — | — | — |
| | R-7 | — | — | — | — | — | — | 100 | — | — | — |
| | R-8 | — | — | — | — | — | — | — | 100 | — | — |
| | R-9 | — | — | — | — | — | — | — | — | 100 | — |
| | R-10 | — | — | — | — | — | — | — | — | — | 100 |
| Organic Solvents | C-1 | 725 | — | — | 100 | 1300 | 1500 | — | 1000 | 725 | 800 |
| | C-2 | 725 | 1500 | — | 550 | — | — | 1500 | — | — | — |
| | C-3 | — | — | 1800 | — | 1350 | — | — | 500 | 50 | 800 |
| Silicon Particles | D-1 | — | — | — | — | — | — | — | 0.5 | — | — |
| | D-2 | — | — | — | — | — | — | — | — | 1 | — |
| | D-3 | — | — | — | — | — | — | — | — | — | 2 |
| Silane Compounds | E-1 | — | — | 10 | — | — | — | — | 6 | — | — |
| | E-2 | — | — | — | — | — | 5 | — | 2 | — | — |
| Evaluation | Release property | ◯ | ◯ | ◯ | ⊚ | ⊚ | ◯ | ⊚ | ◯ | ◯ | ⊚ |
| | Transparency | ◯ | ◯ | ⊚ | ⊚ | ⊚ | ⊚ | ⊚ | ⊚ | ⊚ | ⊚ |

C-1: 1-methyl-2-pyrrolidone
C-2: ethylene glycol n-butyl ether
C-3: N,N-dimethylacetamide
D-1: Aerosil R976 manufactured by Dugussa
D-2: X-52-7030 manufactured by Shin-Etsu Chemical Co., Ltd.
D-3: OSCAR 106 manufactured by Catalysts and Chemicals Ltd.
E-1: 3-aminopropyltrimethoxysilane
E-2: 3-aminopropyltriethoxysilane

As shown in Table 2, all of the substrate structures obtained in Examples 1-10 have good transparency and release property.

### Comparative Example 1

A parylene precursor (parylene dimer) was vapor-deposited on a glass support (15 cm×15 cm) according to the procedure of Example 1 of U.S. Pat. No. 8,173,249 to form a release layer of 8 cm×8 cm on the glass support. However, the yield is inferior and the production cost is relatively high. Therefore, it is not acceptable in the industry.

### Comparative Example 2

A Topas solution (10 wt % of solid content, dissolved in toluene) was coated on a glass support (15 cm×15 cm) according to the procedure of Example 2 of U.S. Pat. No. 8,173,249 to form a release layer of 8 cm×8 cm on the glass support. However, the production cost is relatively high. Therefore, it is not acceptable in the industry.

### Comparative Example 3

A polyimide solution (TM11, manufactured by Taimide Technology Inc., solid content: 15 wt %) was coated onto a glass support using the aforesaid coating machine, followed by pre-baking in a baking oven at a temperature of 100° C. for 10 minutes, and then post-baking at a temperature of 250° C. for 0.5 hour to form a substrate structure without a release layer. The glass support was removed using a laser cutting treatment. However, the flexible substrate thus obtained is liable to swell or be impaired due to the heat produced during the laser cutting treatment. Furthermore, the equipment for performing the laser cutting treatment is expensive, and thus, the production cost cannot be reduced.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A substrate structure comprising:
a support;
a release layer releasably disposed on said support; and
a flexible substrate disposed on said release layer,
wherein said release layer is made from a polymer composition including a polymer component obtained by subjecting a diamine component (A) and a tetracarboxylic dianhydride component (B) to a polymerization reaction.

2. The substrate structure as claimed in claim 1, wherein said tetracarboxylic dianhydride component (B) includes at least one compound selected from the group consisting of an aliphatic tetracarboxylic dianhydride compound (B-1), an alicyclic tetracarboxylic dianhydride compound (B-2), and a fluorine-containing tetracarboxylic dianhydride compound (B-3), a total amount of said aliphatic tetracarboxylic dianhydride compound (B-1), said alicyclic tetracarboxylic dianhydride compound (B-2), and said fluorine-containing tetracarboxylic dianhydride compound (B-3) being at least 30 moles based on 100 moles of said tetracarboxylic dianhydride component (B).

3. The substrate structure as claimed in claim 1, wherein said polymer component has an imidization extent of at least 60%.

4. The substrate structure as claimed in claim 1, wherein said polymer composition further includes silicon particles having an average particle size ranging from 0.1 nm to 10 μm.

5. The substrate structure as claimed in claim 4, wherein said silicon particles are in an amount ranging from 0.1 part by weight to 10 parts by weight based on 100 parts by weight of said polymer composition.

6. A method for making a substrate structure, comprising the steps of:
forming a release layer on a support; and
forming a flexible substrate on the release layer,
wherein the release layer is made from a polymer composition including a polymer component obtained by subjecting a diamine component (A) and a tetracarboxylic dianhydride component (B) to a polymerization reaction.

7. The method as claimed in claim 1, wherein the tetracarboxylic dianhydride component (B) includes at least one compound selected from the group consisting of an aliphatic tetracarboxylic dianhydride compound (B-1), an alicyclic tetracarboxylic dianhydride compound (B-2), and a fluorine-containing tetracarboxylic dianhydride compound (B-3), a total amount of the aliphatic tetracarboxylic dianhydride compound (B-1), the alicyclic tetracarboxylic dianhydride compound (B-2), and the fluorine-containing tetracarboxylic dianhydride compound (B-3) being at least 30 moles based on 100 moles of the tetracarboxylic dianhydride component (B).

8. The method as claimed in claim 6, wherein the polymer component has an imidization extent of at least 60%.

9. The method as claimed in claim 6, wherein the polymer composition further includes silicon particles having an average particle size ranging from 0.1 nm to 10 μm.

10. The method as claimed in claim 9, wherein the silicon particles are in an amount ranging from 0.1 part by weight to 10 parts by weight based on 100 parts by weight of the polymer composition.

11. The method as claimed in claim 6, wherein the release layer is formed on the support by coating.

12. The method as claimed in claim 6, wherein the flexible substrate is formed on the release layer by coating.

13. The method as claimed in claim 6, further comprising a step of stripping the flexible substrate together with the release layer from of the support.

14. The method as claimed in claim 6, wherein the flexible substrate covers the release layer and the support.

15. The method as claimed in claim 14, further comprising a step of cutting the flexible substrate disposed on the support so that the flexible substrate only covers the release layer.

16. The method as claimed in claim 15, further comprising a step of stripping the flexible substrate together with the release layer from the support after the cutting step.
